(19) United States
(12) Patent Application Publication
(10) Pub. No.: US 2022/0243666 A1
(43) Pub. Date: Aug. 4, 2022

(54) FUEL SAMPLE EXTRACTOR

(71) Applicant: Bell Textron Inc., Forth Worth, TX (US)

(72) Inventor: Ralph Michael Gannarelli, Keller, TX (US)

(73) Assignee: Bell Textron Inc., Fort Worth, TX (US)

(21) Appl. No.: 17/168,064

(22) Filed: Feb. 4, 2021

(51) Int. Cl. F02C 9/38; F02C 7/236

(52) U.S. Cl. CPC F02C 9/38; B64D 37/14; F02C 7/236

(57) ABSTRACT

A fuel sample extractor (FSE) for an aircraft includes a sample chamber, a lid configured to seal the sample chamber, a pump in selective fluid communication with an upper portion of the sample chamber, and a straw in selective fluid communication with a lower portion of the sample chamber and a fuel tank.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Prior methods of fuel sampling have been accomplished utilizing gravity driven systems. A manual or drain valve is positioned in a low portion of the fuel tank and access to that valve is external to the fuel tank. A fuel sample is taken by placing a suitable container under the valve so that when it is opened, gravity will cause fuel to drain into the container until the valve is closed. This container is open to the atmosphere, the collected fuel must be disposed of, and the container must be cleaned after collecting the fuel sample.

In the example case of the Bell 505 helicopter, there is no drain as mentioned above, but rather, an internal (to the tank) “pick-up” hose having an opening located at a low portion (sump) of the fuel tank. An external connection to this pick-up hose can be connected to a hand pump and check valve assembly to draw out fuel by manually actuating the pump. Back and forth action of the pump handle pulls fuel from the internal sump into the pump and then discharges the fuel into a suitable container which is open to the atmosphere. This method is messy and inconvenient, inducing some people to avoid checking fuel quality and potentially leading to a safety issue.

### BRIEF DESCRIPTION OF THE DRAWINGS

FIG. 1 is a side view of a helicopter connected to a fuel sample extractor according to this disclosure.

FIG. 2 is a schematic side view of the fuel sample extractor of FIG. 1 connected to a fuel tank of the helicopter of FIG. 1 and configured to receive a fuel sample.

FIG. 3 is a schematic side view of the fuel sample extractor of FIG. 1 connected to a fuel tank of the helicopter of FIG. 1 and configured to return a fuel sample.

FIG. 4 is a flowchart of a method of using the fuel sample extractor of FIG. 1.

FIG. 5 is a schematic side view of an alternative embodiment of a fuel sample extractor connected to a fuel tank of the helicopter of FIG. 1 and configured to return a fuel sample.

FIG. 6 is a schematic side view of another alternative embodiment of a fuel sample extractor that is incorporated into the helicopter of FIG. 1.

FIG. 7 is a schematic side view of another alternative embodiment of a fuel sample extractor that is incorporated into the helicopter of FIG. 1.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

This disclosure teaches a fuel sample extractor for extracting a fuel sample for analysis from an aircraft such as, but not limited to, a helicopter. The fuel sample extractor can be made using any appropriate materials without undue experimentation by a person having ordinary skill in the art. It should be appreciated that any hoses or valves should be connected such that a volume of liquid may be properly conveyed without leakage.

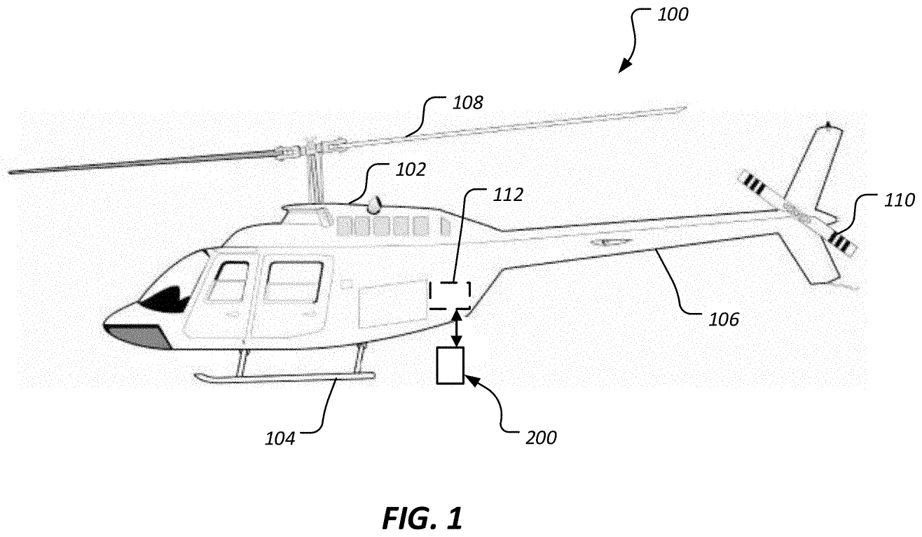

Referring to FIG. 1, a helicopter 100 is illustrated. Helicopter 100 comprises a fuselage 102, landing gear 104, a tail boom 106, main rotor blades 108, tail rotor blades 110, and a fuel tank 112. FIG. 1 also shows a fuel sample extractor (FSE) 200 associated with the fuel tank 112. The FSE 200 is removably connected to fuel tank 112 and can be used to selectively remove a fuel sample from fuel tank 112 and selectively return the fuel sample to fuel tank 112.

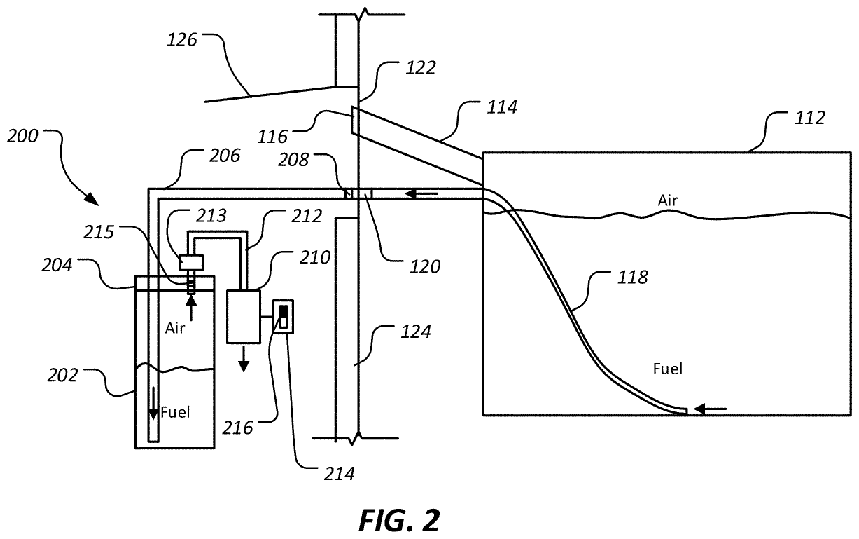

Referring now to FIG. 2, FSE 200 is shown in detail and is connected to fuel tank 112 and configured to extract a fuel sample from fuel tank 112. Helicopter 100 is shown as further comprising a fueling neck 114 having a fuel cap 116. The fuel cap 116 and optionally a portion of the fueling neck 114 extend from an interior of the fuselage 102 from an upper portion of fuel tank 112 to a space between an inner surface 122 and an access door 126. The space is generally bounded fore/aft and above/below by a wall 124 of fuselage 102. Helicopter 100 further comprises a sump hose 118 that has an open end located within fuel tank 112 and near the bottom of fuel tank 112. The remaining end of sump hose 118 is connected to a sump quick connect fitting 120 that comprises an automatically closing valve and quick connect fitting 120 extends at least partially into the space between inner surface 122 and access door 126.

FSE 200 is shown in detail and comprises a sample chamber 202 (such as a glass bottle) and a lid 204 configured to provide a fluid tight seal with sample chamber 202. Sample chamber 202 is used to receive the fuel sample from fuel tank 112. FSE 200 further comprises a chamber straw 206 that extends from a lower portion of the sample chamber 202, through lid 204 in a sealed manner, and terminates with a straw quick connect fitting 208 that is configured to cooperate with the sump quick connect fitting 120 to selectively provide a fluid flow path between a lower portion of fuel tank 112 and a lower portion of sample chamber 202. FSE 200 further comprises a pump system 210 that comprises an electric motor and a fluid pump configured to generate a vacuum and/or a pressure that is selectively driven by the electric motor. FSE 200 also comprises a pump line 212 connected between pump system 210 and sample chamber 202. Pump line 212 extends through lid 204 in a sealing manner so that when the motor of pump system 210 is driven in a first direction, pump system 210 removes air from an upper portion of sample chamber 202 via pump line 212, thereby reducing a pressure within sample chamber 202. In some embodiments, a valve 213 is disposed along pump line 212 to allow selective closure of pump line 212 so that an obtained pressure within sample chamber 202 can be substantially maintained without continued operation of pump system 210. Additionally, in some embodiments, a check valve 215, float ball, or other directional device configured to prevent liquid fuel from entering pump line 212 from sample chamber 202. In this embodiment, pump system 210 is powered by a power source 214 comprising a plurality of batteries and is controlled by a control switch 216 that manages delivery of direct current to the motor of pump system 210.

In operation, FSE 200 can be used to evaluate fuel quality of fuel within fuel tank 112 by first opening access door 126 to gain access to sump quick connect fitting 120. With access door 126 open, straw quick connect fitting 208 can be connected to sump quick connect fitting 120, thereby creating a fluid flow path between the lower portion of fuel tank 112 and the lower portion of sample chamber 202. Next, control switch 216 can be operated to initiate operation of the motor of pump system 210 in a direction that removes air from sample chamber 202, thereby reducing a pressure within sample chamber 202. When pressure within sample chamber 202 is sufficiently reduced, fuel can begin flowing up through sump hose 118, through fittings 120, 208, and into sample chamber 202 via chamber straw 206. One purpose of utilizing FSE 200 is to allow visual inspection of the fuel sample captured within sample chamber 202 without the sample first having to pass through a pump or other device, which could potentially contaminate the sample. When sufficient fuel is captured within sample chamber 202, pump system 210 can be deactivated and/or valve 213 can be actuated to discontinue changing pressure within sample chamber 202.

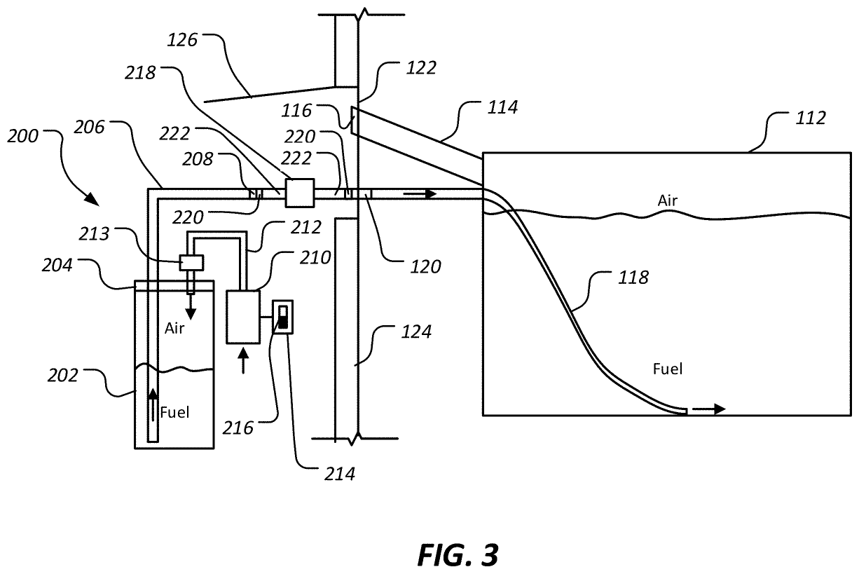

Referring now to FIG. 3, FSE 200 is shown in a configuration for returning fuel from sample chamber 202 to fuel tank 112. In this embodiment, control switch 216 is configured to selectively deliver direct current to the motor of pump system 210 in a reversible manner. As described with reference to FIG. 2, direct current is supplied to pump system 210 to drive motor in a first direction that moves the pump to remove air from sample chamber 202. However, as shown in FIG. 3, direct current is supplied to pump system 210 to drive motor in a second direction that moves the pump to supply air to sample chamber 202 by positioning the control switch 216 differently than shown in FIG. 2. In this manner, air can be pumped into sample chamber 202 via pump line 212 thereby increasing a pressure within sample chamber 202. When the pressure within sample chamber 202 is sufficient, fuel within sample chamber 202 will be pushed up chamber straw 206 and back to fuel tank 112 via sump hose 118. In some embodiments, a fuel filter 218 can be disposed between sample chamber 202 and fuel tank 112 by connecting fittings 120, 208 to filter quick connect fittings 220 which connect to fuel filter 218 with filter lines 222. Once fuel is returned to fuel tank 112 from sample chamber 202, FSE 200 can be disconnected from helicopter 100 and stored.

In alternative embodiments of an FSE substantially similar to FSE 200, the chamber straw 206 may not extend to the bottom of the sample chamber. In such an embodiment, the FSE is not equipped to return the fuel sample to the fuel tank, but rather, the fuel sample can simply be disposed of.

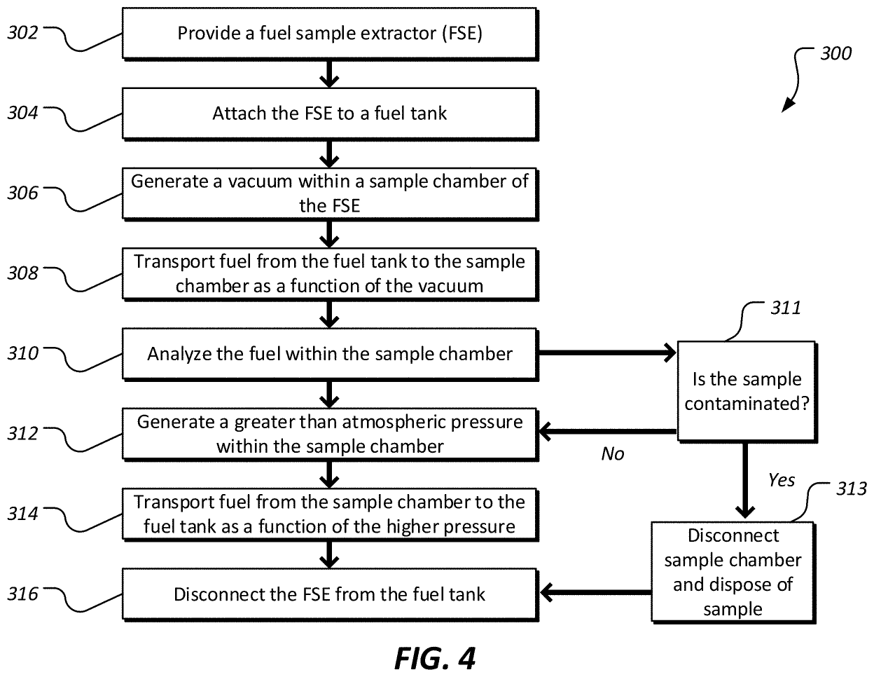

Referring now to FIG. 4, a flowchart of a method 300 of operating a FSE 200 is shown. Method 300 can begin at block 302 by providing an FSE such as FSE 200. Method 300 can progress at block 304 by connecting the FSE to a fuel tank, such as a fuel tank 112 of helicopter 100. Next, method 300 can progress at block 306 by generating a reduced pressure or vacuum within a sample chamber of the FSE. At block 308, the method 300 can continue by, in response to the reduced pressure, transporting fuel from the fuel tank to the sample chamber. Next, the method 300 can continue at block 310 by analyzing the fuel sample collected within the sample chamber. In some cases, a visual inspection of the fuel through an at least partially transparent wall of the sample chamber can be conducted. However, in other embodiments, electronic sensors and/or chemical agents can be utilized to evaluate the fuel sample. Next, method 300 can continue at block 312 by increasing a pressure within the sample chamber. At block 314, when the pressure within the sample chamber is sufficiently increased, method 300 can continue by transporting the fuel from the sample chamber and back into the fuel tank. Finally, method 300 can conclude at block 316 by disconnecting the FSE from the fuel tank.

In some embodiments, method 300 can additionally comprise determining whether the collected fuel sample is contaminated. More specifically, from block 310, the method can continue at block 311 by determining whether the fuel sample is contaminated. When the sample is not contaminated, the method can continue at block 312. When the sample is contaminated, the method can progress to block 313 by disconnecting the sample chamber and disposing of the contaminated fuel sample and thereafter progressing to block 316.

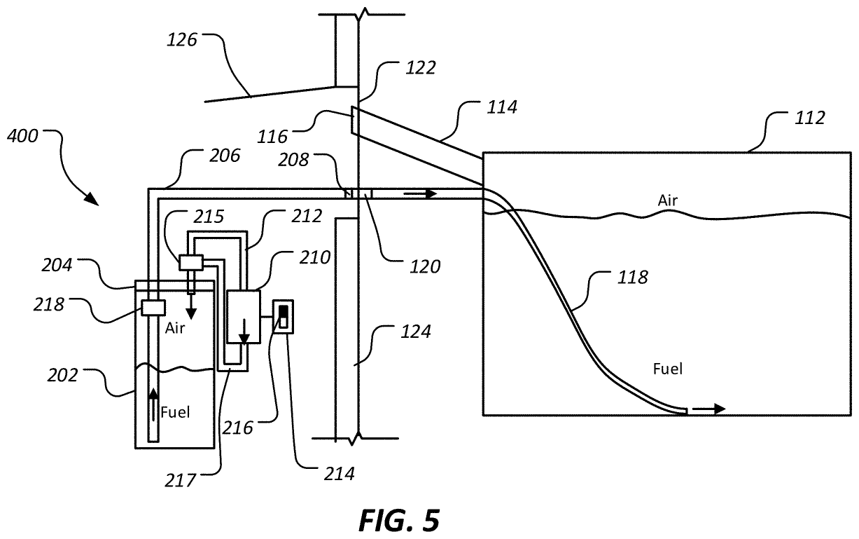

Referring now to FIG. 5, an alternative embodiment of a FSE 400 is shown. In this embodiment, to return fuel back to fuel tank 112 from sample chamber 202, rather than reversing a direction of movement of the motor within pump system 210, FSE 400 is further provided with a combination valve 215 and a reversing line 217 connected to an output of pump system 210. As shown, when delivering fuel back to fuel tank 112, combination valve 215 is configured to disconnect from sample chamber 202 the pump line 212 that connects to a pump input and open reversing line 217 that connects to a pump output. Combination valve 215 can further be configured to allow intake of air into pump line 212 so that when pump system 210 is operated, air is drawn in through pump line 212 from the atmosphere rather than from sample chamber 202 and air is outputted into sample chamber 202 via reversing line 217.

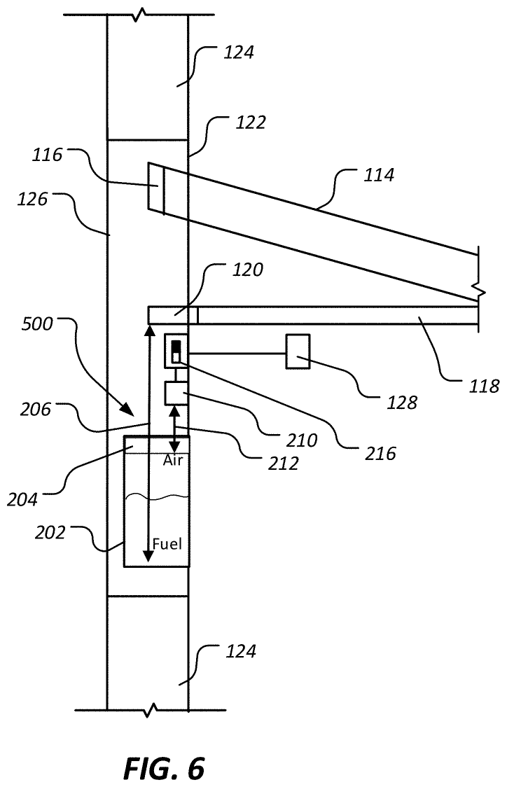

Referring now to FIG. 6, an alternative embodiment of a FSE 500 is shown. FSE 500 is substantially similar to FSE 200, but rather than being primarily a portable and quickly removable system, it is mounted within the space between the inner surface 122 and the access door 126 so that when access door 126 is opened, a user gains access to the FSE 500, fuel cap 116, and sump quick connect fitting 120. Another primary difference is that FSE 500 does not rely on a dedicated external power source (such as a battery pack), but rather, is integrally wired to a power system 128 of helicopter 100. Power system 128 can comprise a power bus that connects FSE 500 to one or more of a battery, an onboard generator, and a ground based auxiliary power unit.

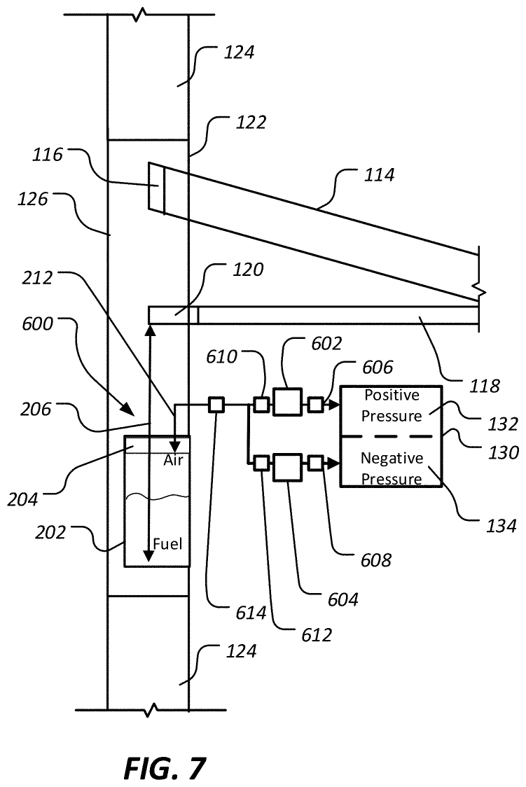

Referring now to FIG. 7, an alternative embodiment of a FSE 600 is shown. FSE 600 is substantially similar to FSE 500, but rather than comprising an electrically driven motor and an associated vacuum pump, FSE 600 utilized air pressure differential supplied by the helicopter 100 to drive fuel samples to and from the sample chamber 202. More specifically, a power plant 130 comprising a positive pressure supply 132 and a negative pressure supply 134 is utilized to charge and evacuate a positive pressure chamber 602 and a vacuum chamber 604, respectively. A positive pressure check valve 606 is disposed between the positive pressure supply 132 and the positive pressure chamber 602 to allow introduction of gas into the positive pressure chamber 602 without allowing gas to flow from the positive pressure chamber 602 back to the positive pressure supply 132. Similarly, a vacuum pressure check valve 608 is disposed between the negative pressure supply 134 and the vacuum chamber 604 to allow removal of gas from the vacuum chamber 604 without allowing gas to flow from the negative pressure supply 134 back to the vacuum chamber 604. Further, each of the positive pressure chamber 602 and the vacuum chamber 604 are connected to the pump line 212 via valves 610, 612, respectively. Finally, FSE 600 comprises a sample transfer valve 614 that is utilized to selectively connect the sample chamber 202 to the positive pressure chamber 602 and vacuum chamber 604.

In operation, FSE 600 can be utilized to draw a fuel sample from fuel tank 112 by first operating the power plant 130 to cause a negative pressure or vacuum pressure within vacuum chamber 604. This can be accomplished during or prior to drawing the fuel sample from the fuel tank 112. Next, valve 612 can be opened to connect the vacuum chamber 604 to the sample transfer valve 614. Next, the sample transfer valve 614 can be actuated to apply a negative or vacuum pressure to the sample chamber 202, thereby drawing a fuel sample into the sample chamber 202. Once the fuel sample has been introduced to the sample chamber 202, the sample transfer valve 614 can be closed to discontinue drawing fuel into the sample chamber 202. Next, the valve 612 can be closed.

To return the fuel sample to the fuel tank 112, the power plant 130 can be operated to cause a positive pressure within positive pressure chamber 602. This can be accomplished during or prior to returning the fuel sample to the fuel tank 112. Next, valve 610 can be opened to connect the positive pressure chamber 602 to the sample transfer valve 614. Next, the sample transfer valve 614 can be actuated to apply a positive pressure to the sample chamber 202, thereby pushing the fuel sample from the sample chamber 202 back into the fuel tank 112. Once the fuel sample has been returned to the fuel tank 112, the sample transfer valve 614 can be closed to discontinue pushing fluid toward the fuel tank 112. Next, the valve 610 can be closed.

In some embodiments, each of the vacuum chamber 604 and the positive pressure chamber 602 can be pressurized during operation of the power plant 130 to a degree that FSE can be used as described above even when the power plant 130 is not operating.

FSE embodiments disclosed herein allow extraction, storage and analyzation, and return of a fuel sample without exposing the liquid fuel to an open environment, thereby greatly reducing or eliminating the escape of noxious fuel fumes. Further, because only air and not the fuel passes through the pump system, the pump system need not be primed, emptied, or cleaned between uses, thereby making the entire process more time efficient and allowing a longer pump life.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. A fuel sample extractor (FSE) for an aircraft comprising:
a sample chamber;
a lid configured to seal the sample chamber;
a pump in selective fluid communication with an upper portion of the sample chamber; and
a straw in selective fluid communication with a lower portion of the sample chamber and a fuel tank.

2. The FSE of claim 1, wherein the sample chamber comprises an at least partially transparent bottle.

3. The FSE of claim 1, wherein the selective fluid communication between the upper portion of the sample chamber and the pump comprises a pump line that extends through the lid.

4. The FSE of claim 1, wherein the straw extends through the lid.

5. The FSE of claim 1, further comprising:
an electric motor configured to drive the pump a first direction to remove air from the sample chamber.

6. The FSE of claim 5, wherein the electric motor is reversible to drive the pump in a second direction to provide air to the sample chamber.

7. The FSE of claim 5, wherein the electric motor is powered by a battery.

8. The FSE of claim 5, wherein a combination valve and a reversing line attached to an output of the pump are provided to selectively switch between removing air from the sample chamber and providing air to the sample chamber.

9. An aircraft, comprising:
a fuel tank;
a sump hose in fluid communication with a lower portion of the fuel tank; and
a fuel sample extractor (FSE), comprising:
a sample chamber;
a lid configured to seal the sample chamber;
a pump in selective fluid communication with an upper portion of the sample chamber; and
a straw in selective fluid communication with a lower portion of the sample chamber and the sump hose.

10. The aircraft of claim 9, wherein the straw and the sump hose are selectively connected to each other using quick connect fittings comprising self-closing valves.

11. The aircraft of claim 9, wherein the pump is driven by a motor powered by a power system carried by the aircraft.

12. A method of obtaining a fuel sample from a fuel tank, comprising:
providing a fuel tank comprising fuel;
providing a sample chamber; and
providing a pump to cause fuel to flow from the fuel tank to the sample chamber without passing the fuel through the pump.

13. The method of claim 12, wherein the pump is configured to remove air from the sample chamber.

14. The method of claim 12, wherein the fuel is removed from the fuel tank via a sump hose.

15. The method of claim 12, wherein the fuel is provided to the sample chamber through a straw having an outlet near a lower portion of the sample chamber.

16. The method of claim 12, wherein the pump is reversible.

17. The method of claim 12, wherein a combination valve is provided to selectively allow the pump to provide air to the sample chamber.

18. The method of claim 12, further comprising:
returning fuel to the fuel tank from the sample chamber by increasing a pressure within the sample chamber.

19. The method of claim 12, further comprising:
visually analyzing the fuel within the sample chamber through an at least partially transparent portion of the sample chamber.

20. The method of claim 19, further comprising:
filtering the fuel before returning the fuel to the fuel tank from the sample chamber.
